(19) United States
(12) Patent Application Publication
(10) Pub. No.: US 2007/0030453 A1
(43) Pub. Date: Feb. 8, 2007

(54) System and method for increasing the brightness of an image

(76) Inventor: Brent Hoffman, Mooresville, IN (US)

Correspondence Address: Barry D. Blount;FLETCHER YODER, P.O. Box 692289, Houston, TX, 77269-2289, US

(21) Appl. No.: 11/196,139

(22) Filed: Aug. 2, 2005

(51) Int. Cl. G03B 1/00

(52) U.S. Cl. 352/166

(57) ABSTRACT

The disclosed embodiments relate to a system and method for increasing the brightness of a video image. More specifically, there is provided a method comprising determining a color temperature setting, determining a period of time when a light source (12) is shinning through a color filter (40, 42, 44, 46, 48, and 50) corresponding to the color temperature setting, and pulsing the light source (12) with a pulse current during the period of time.

### FIELD OF THE INVENTION

The present invention relates generally to projecting video images onto a screen. More specifically, the present invention relates to a system for increasing brightness of a projected video image.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

White light is composed of the combination of the three primary colors of light: red light, green light, and blue light. When the red light, green light, and blue light are present in equal amounts, a “pure” white light is created. However, if the primary colors are not mixed evenly, the resulting white light may have a visible tint or color cast. For example, while the light from an incandescent bulb is white, it may have a reddish cast; whereas daylight, which also appears generally white, has more of a bluish cast. This subtle color bias in generally white light is referred to as the color temperature, and the color temperature of an image is a measure of the color tint of the white light used to create that image. Because the color temperature can affect the look and/or feel of a video image controlling the color temperature of video images is typically a consideration in video display units, such as televisions, video projectors, and so forth. In fact, many video display units allow users to select or set the color temperature of the images that the display unit is displaying.

Many types of video display units employ high intensity light sources, such as metal halide lamps, mercury vapor lamps, and the like. In a typical video display unit, the light generated from the high intensity light source passes through a color wheel that converts the stream of white light generated by the high intensity light source into a stream of light that rapidly and repeatedly changes from red light to green light to blue light. The video display unit may use this red, green, and blue light to create a red image, a green image, and a blue image, which are each projected onto a screen. Because the red, green, and blue images are displayed in relatively quick succession, a person watching the video display unit sees a single video image formed from the red image, the green image, and the blue image.

Typically, however, video display units employing high intensity light sources are configured to periodically pulse the high intensity light sources with a slightly higher supply current (referred to as a pulse current) to stabilize arcing on the electrodes within the high intensity light source. However, because the pulse current is higher than the normal supply current for the high intensity light source, during the pulse, the light output from the high intensity light source is increased. Conventional video display units are configured to pulse the high intensity light source with a fixed waveform with a fixed time phase with respect to the color wheel rotation. Thus the pulse is always placed during the same segment of the color wheel (blue, for example) irregardless of the desired color temperature chosen by the customer.

As described earlier, however, the color temperature of a video image is a function of the mix of red light, green light, and blue light that make up the white light in the image. As such, increasing the brightness of the blue light can affect the color temperature of video images. This phenomenon may not be a concern if the video display unit is set at a cooler (i.e., more blue) color temperature. However, if the video display unit is set at a warmer color temperature (i.e., more red or more green), the video display unit may have to actively reduce the brightness of the blue component of the video image to compensate for the increase light output during the pulse. This reduction in brightness reduces the overall brightness of the video image. Embodiments of the present invention may relate to a system and a method for boosting the brightness of a video image while maintaining a desired colored temperature.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the disclosed invention relate to a system and method for increasing the brightness of a video image. More specifically, there is provided a method comprising determining a color temperature setting, determining a period of time when a light source is shinning through a color filter corresponding to the color temperature setting, and pulsing the light source with a pulse current during the period of time.

### BRIEF DESCRIPTION OF THE DRAWINGS

Advantages of the invention may become apparent upon reading the following detailed description and upon reference to the drawings in which:

FIG. 1 is a block diagram of a video unit configured to increase the brightness of an image in accordance with embodiments of the present invention;

FIG. 2 is a diagram of a color wheel configured to increase the brightness of an image in accordance with embodiments of the present invention; and

FIG. 3 is a flow chart illustrating an exemplary technique for increasing the brightness of an image in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

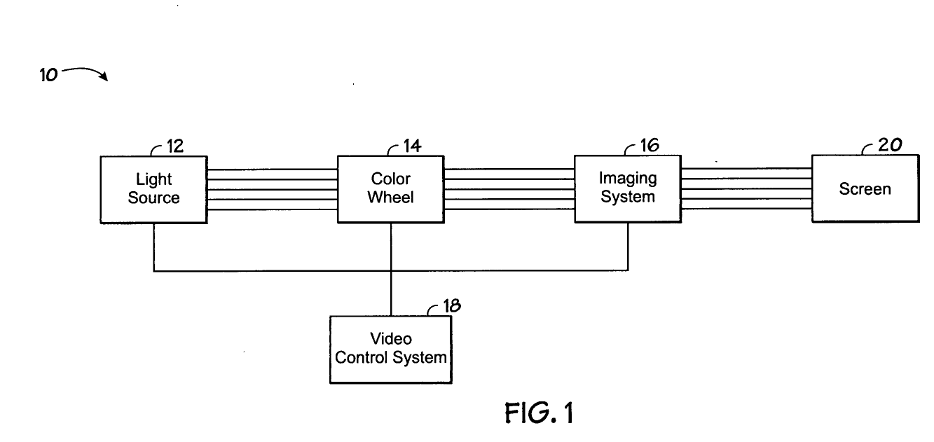

Turning initially to FIG. 1, a block diagram of a video unit configured to increase the brightness of a video image in accordance with one embodiment is illustrated and generally designated by a reference numeral 10. In one embodiment, the video unit 10 may comprise a Digital Light Processing (“DLP”) projection television or projector. In another embodiment, the video unit 10 may comprise a liquid crystal diode (“LCD”) projection television. In still other embodiments, the video unit 10 may comprise another suitable form of projection television or display.

The video unit 10 may comprise a light source 12. The light source 12 may include any suitable form of lamp or bulb capable of projecting white or generally white light. In one embodiment, the light source 12 may be a high intensity light source, such as a metal halide lamp or a mercury vapor lamp. For example, the light source 12 may be an ultra high performance (“UHP”) lamp produced by Phillips Electronics. In one embodiment, the light source 12 is configured to project, shine, or focus the generally white light into one static location as described further below. As illustrated in FIG. 1, the exemplary video unit 10 also includes a color wheel 14 aligned in an optical line of sight of the light source 12.

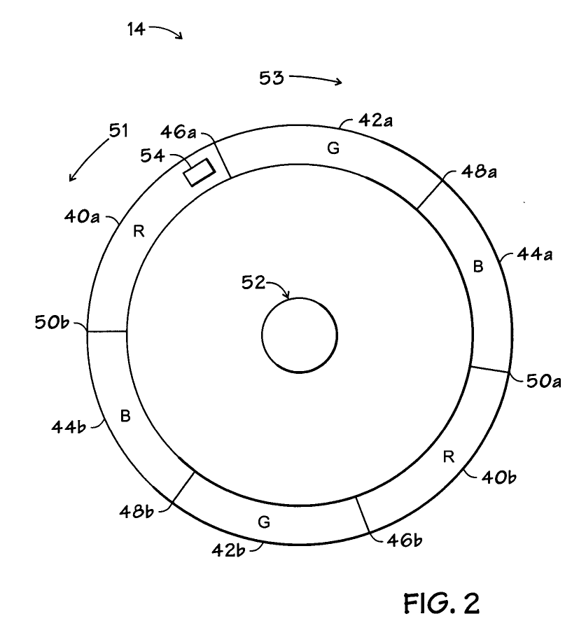

FIG. 2 is a diagram of the color wheel 14 configured to increase the brightness of an image in accordance with one embodiment. The color wheel 14 may include a variety of color filters 40a, 40b, 42a, 42b, 44a, and 44b arrayed as arcuate regions on the color wheel 14. In the illustrated embodiment, the color wheel 14 comprises color filters 40a, 40b, 42a, 42b, 44a, and 44b configured to convert generally white light into one of the three primary colors of light: red, green, or blue. In particular, the illustrated embodiment of the color wheel 14 comprises two red color filters 40a and 40b, two green color filters 42a and 42b, and two blue color filters 44a and 44b. It will be appreciated that in alternate embodiments, the specific colors of the filters 40a, 40a, 42a, 42b, 44a, and 44b may be altered or the number of filters may be altered. For example, in one alternate embodiment, the color wheel 14 may comprise only one red color filter 40a, one green color filter 42a, and one blue color filter 44a. In this embodiment, the arcuate regions occupied by the color filters 42a, 44a, and 46a may be approximately twice as long (as measured along the circumference of the color wheel 14) than the color filters 40a, 40b, 42a, 42b, 44a, and 44b depicted in FIG. 2. In still other embodiments, the color filters 40a, 40b, 42a, 42b, 44a, and 44b may occupy either more or less of the surface area of the color wheel depending on the configuration and function of the video unit 10.

In addition, the color wheel 14 may comprise boundaries between each of the filters 40a, 40b, 42a, 42b, 44a, and 44b. These boundaries are known as spokes 46a, 46b, 48a, 48b, 50a, and 50b due to their resemblance to the spokes of wheel. For example, FIG. 2 illustrates three types of spokes: the yellow (i.e., red-green) spokes 46a and 46b, the cyan (i.e., green-blue) spokes 48a and 48b, and the magenta (i.e., blue-red) spokes 50a and 50b.

Turning next to the operation of the color wheel 14, each of the filters 40a, 40b, 42a, 42b, 44a, and 44b is designed to convert the white light 28 generated by the light source 12 into colored light 30. In particular, the color wheel 14 may be configured to rapidly spin in a counterclockwise direction 51 around its center point 52. The light source 12 may then be configured to focus generally white light at the color wheel 14. On the opposite side of the color wheel 14 from the light source 12, there may be an imaging system 16, because the location of the imaging system 16 is fixed and the color wheel 14 rotates, the light that enters the imaging system 16 can be illustrated as a fixed area 54 that rotates around the color wheel 14 in the opposite direction from the color wheel 14 direction of rotation.

For example, as the color wheel 14 rotates in the counterclockwise direction 51, the fixed area 54 rotates through each the filters 40a, 40b, 42a, 42b, 44a, and 44b in the clockwise direction 53. As such, the colored light entering the imaging system 16 rapidly change from red to green to blue to red to green to blue with each rotation of the color wheel 14 as the fixed area 54 passes through each of the color filters 40a, 40b, 42a, 42b, 44a, and 44b. In other words, because the light source 12 is stationary, the counterclockwise rotation of the color wheel 14 causes the fixed area 54 to rotate in a clockwise direction 53 through the colors of the color wheel 14. In alternate embodiments, the color wheel 14 itself may rotate in the clockwise direction 53. Those skilled in the area will appreciate that the size and shape of the fixed area 54 is merely illustrative. In alternate embodiments, the size and shape of the fixed area 54 may be different depending on the optical design of the system.

Returning now to FIG. 1, the red, green, and blue light exiting the color wheel 14 may enter the imaging system 16. The imaging system 16 may be configured to employ the red, green, and blue light to create an image suitable for display on a screen 20. In one embodiment, the imaging system 16 comprises a digital light processing (“DLP”) imaging system that employs one or more digital micromirror devices (“DMD”) to generate a video image using the red, green, and blue light. In another embodiment, the imaging system 16 may employ an LCD projection system. It will appreciated, however, that the above-describe exemplary embodiments are not intended to be exclusive, and that in alternate embodiments, any suitable form of imaging system 16 may be employed in the video unit 10.

In addition, the imaging system 16 may also be configured to display (i.e., project) images at a desired or target color temperature. In one embodiment, a user of the video unit 10 may be able to set the color temperature of the video unit 10. For example, the color temperature could be set to cool, normal, or warm. In one embodiment, color temperature is quantified using the CIE system, which characterizes color temperature using two color coordinates x and y that specify a particular point on the chromaticity diagram. For example, the imaging system may be set to display images using a warm temperature, such as x CIE=0.313, y CIE=0.329.

Once a color temperature has been set, the imaging system may be configured to actively reduce the brightness of the red, green, or blue light received from the color wheel 14, as appropriate, to achieve the desired color temperature. For example, if the desired color temperature is warm, the imaging system 16 may reduce the brightness of the blue light to create a warm image. In one embodiment, the imaging system 16 may reduce the brightness of one of the colors of light by reflecting more of overly bright color of light away from a screen 20 (e.g., to a light absorber). As will be described further below, the video unit 16 is designed to decrease this reduction in brightness compared to conventional video units.

As shown in FIG. 1, the light source 12, the color wheel 14, and the imaging system 16 may also be communicatively coupled to a video control system 18. In one embodiment, the video control system may include one or more processors, associated memory, and/or other suitable control system components. The video control system 18 may be configured to control the function and operation of the light source 12, the color wheel 14, and the imaging system 16. For example, the video control system 18 may be configured to synchronize the operation of the light source 12, the color wheel 14, and the imaging system 16. As will be described in detail further below, in one embodiment, the video control system 18 may be configured to synchronize a current pulse to the light source 12 with a particular position of the fixed area 54 on the color wheel 14 with the position of a plurality of micromirrors located on a DMD within the imaging system 16.

As described above, the light source 12 may include a high intensity light source, such as a metal halide lamp, a mercury vapor lamp, or a UHP lamp. These types of lamps are typically “pulsed” periodically with a slightly higher supply current to stabilize arching on the electrodes of the lamp. For example, the light source 12 may be pulsed with a pulse current 1.2 time the amperes of the supply current. Because the light output from the light source 12 increases during the pulses, the video control system 18 may be configured to control the timing of the pulse current to increase the brightness of the video unit 10. More specifically, the video control system 18 may be configured to set the timing for the pulsing current based on a desired color temperature of the imaging system 16. In other words, the video control system 18 may be configured to time the pulses such that the higher light output resulting from the pulse occurs when the light source 12 is shinning through a color filter on the color wheel 14 that corresponds to the desired color temperature. In one embodiment, the video control system may be configured to time the pulses such that the light output is maximized for a given light source 12

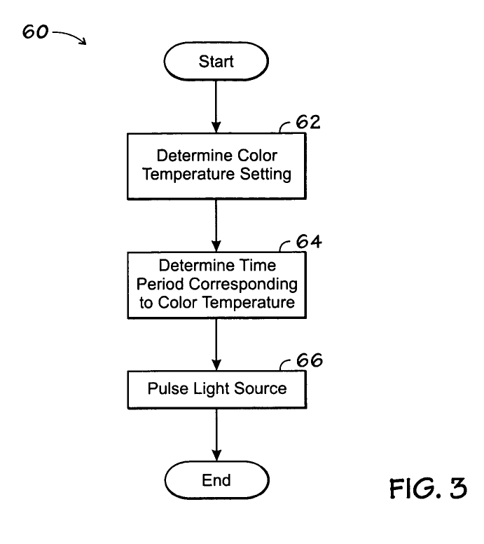

For example, FIG. 3 is a flow chart illustrating an exemplary technique 60 for increasing the brightness of an image in accordance with one embodiment. In one embodiment, the technique 60 may be performed by the video control system 18 in conjunction with the light source 12, the color wheel 14, and the imaging system 16. As illustrated in FIG. 3, the technique 60 may begin by determining a color temperature setting of the imaging system 16, as indicated by block 62 For example, the imaging system 16 may have been set to display video images at a cool temperature (x CIE=0.271, y CIE=0.286, for example).

Once the color temperature setting has been determined, the video control system 18 may determine a time period during the rotation of the color wheel 14 that corresponds to the color temperature, as indicated in block 64. For example, if the color temperature is cool, the time period may be the time when the fixed area 54 is passing through the color filters 44a and 44b (the blue filters). Whereas, if the imaging system is configured to display video images using a normal or warm temperature (x CIE=0.313, y CIE=0.329, for example), the video control system 18 may be configured to determine a time period when the fixed area 54 is passing through the color filters 40a and 40b (the red filters).

Once the time period corresponding to the color temperature has been determined, the video unit 10 may pulse the light source 12 during the time period. For example, if the time period takes place when the fixed area 54 is passing through the red color filters 40a and 40b, the light source 12 will be pulsed when the fixed area 54 is passing through the color filters 40a and 40b. It will be appreciated, however, that the embodiments described above are merely exemplary, and that in alternate embodiments, the video control system 18 may also be configured to pulse the light source 12 while the fixed area 54 is passing through the color filters 42a and 42b or while the fixed area 54 is passing through one or more of the spokes 46a 46b, 48a, 48b, 50a, and 50b depending on the temperature setting of the imaging system 16.

The pulsing of the light source 12 (and thus the increase in light output) is coordinated to occur when the fixed area 54 is passing through a region of the color wheel 14 that corresponds to the color temperature setting of the imaging system 16. Accordingly, the imaging system 16 may not need to reduce the brightness of the light generated during the pulse current. Alternatively, the reduction in brightness of the light generated during the pulse current may be lower than would otherwise be required. As such, the techniques described herein enable the video unit 10 to produce images with improved brightness

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising:
determining a color temperature setting;
determining a period of time when a light source (12) is shinning through a color filter (40, 42, 44, 46, 48, and 50) corresponding to the color temperature setting; and
pulsing the light source (12) with a pulse current during the period of time.

2. The method of claim 1, comprising identifying the color temperature setting as corresponding to a blue color filter (44).

3. The method of claim 1, comprising identifying the color temperature setting as corresponding to a red color filter (40).

4. The method of claim 1, wherein determining the period of time comprises determining the period of time that maximizes the light output for the color temperature setting.

5. The method of claim 1, wherein the light source (12) comprises a metal halide light source.

6. The method of claim 1, wherein the light source (12) comprises an ultra high performance light source.

7. The method of claim 1, wherein determining the color temperature setting comprises determining the color temperature of a television.

8. The method of claim 1, comprising:
generating a beam of light during the time period; and
reflecting the generated beam of light off of a digital micromirror device.

9. A video unit (10) comprising:
a light source (12);
a color wheel that comprises a plurality of color filters (40, 42, 44, 46, 48, and 50) and is adapted to receive light from the light source (12)
a video control system (18) configured to:
determine a color temperature setting for the video unit (10);
determine a period of time when a light source (12) is shinning through one of the plurality of color filters (40, 42, 44, 46, 48, and 50) corresponding to the color temperature setting; and
pulse the light source (12) with a pulse current during the period of time.

10. The video unit (10) of claim 9, wherein one of the plurality of color filters corresponding to the color temperature comprises a blue color filter (44).

11. The video unit (10) of claim 9, wherein one of the plurality of color filters corresponding to the color temperature comprises a red color filter (40).

12. The video unit (10) of claim 9, wherein one of the plurality of color filters corresponding to the color temperature comprises a magenta spoke region (50).

13. The video unit (10) of claim 9, wherein the light source (12) comprises a metal halide light source.

14. The video unit (10) of claim 13, wherein the light source (12) is configured to:
generate a beam of light during the time period; and
shine the generated beam of light through a color wheel.

15. The video unit (10) of claim 9, wherein the video unit (10) comprises a digital light processing display unit.

16. A video unit (10) comprising:
means for determining a color temperature setting;
means for determining a period of time when a light source (12) is shinning through a color filter (40, 42, 44, 46, 48, and 50) corresponding to the color temperature setting; and
means for pulsing the light source (12) with a pulse current during the period of time.

17. The video unit (10) of claim 16, wherein the means for identifying the color temperature setting as corresponding to a blue color filter (44).

18. The video unit (10) of claim 16, wherein the means for determining the color temperature setting comprises means for identifying the color temperature as a warm color temperature.

19. The video unit (10) of claim 16, wherein the means for identifying the color temperature setting as corresponding to a red color filter (40).

20. The video unit (10) of claim 16 comprising:
means for generating a beam of light during the time period; and
means for reflecting the generated beam of light off of a digital micromirror device.
